(19) United States
(12) Patent Application Publication
(10) Pub. No.: US 2007/0280814 A1
(43) Pub. Date: Dec. 6, 2007

(54) System and method to build mixed pallet layers from full pallet layers

(75) Inventors: Sylvain-Paul Morency, Laval (CA); Marc Ducharme, Longueuil (CA)

Correspondence Address: VENABLE LLP, P.O. BOX 34385, WASHINGTON, DC, 20043-9998, US

(73) Assignee: AXIUM Inc., Montreal (CA)

(21) Appl. No.: 11/798,911

(22) Filed: May 17, 2007

Related U.S. Application Data
(60) Provisional application No. 60/747,420, filed on May 17, 2006.

(51) Int. Cl. B65G 57/00

(52) U.S. Cl. 414/788

(57) ABSTRACT

A method and system to build mixed pallet layers from full pallet layers comprises a palletizing/de-palletizing system, a feeding system for feeding the full pallet layers to the palletizing/de-palletizing system; and a mixed pallet output system for receiving the mixed pallet layers from the palletizing/de-palletizing system. The palletizing/de-palletizing system includes a ball table to receive and support the full pallet layers of products and to support the mixed pallet layers; a plurality of product accumulating rows located adjacent the ball table for receiving and accumulating identical products from the full pallet layers and a robot, provided with a tool, to pick products from one of the full pallet layers on the table, to store the products in a selected one of the accumulating rows, and to form a mixed pallet layer on the table by picking selected products in the accumulating rows and by positioning the selected products according to a mixed layer pattern.

### CROSS-REFERENCE TO RELATED APPLICATION

This application claims benefit of U.S. Provisional Application No. 60,747,420, filed May 17, 2006, the content of which is incorporated herein by reference.

### SUMMARY OF THE INVENTION

The present invention relates to palletizing systems. More specifically, the present invention relates to a system and method to build mixed pallet layers from full pallet layers.

There is an increasing need for palletizing applications, for example in managing product orders. Many innovations have seen the light in the well-known field of order picking. However, the proposed solutions are often complex and imply implementing space-consuming systems.

A particular application where there is a need for a simple and fast solution to palletizing full mixed layers of similar boxes is in breweries or in other similar beverage bottlers.

Indeed, in breweries, a few numbers of products with similar format represent the major part of the daily orders. For example, in a typical North American brewery, 10 to 20 SKU (Stock Keeping Units) of 24 bottles and 12 bottles of 341 ml can make the biggest volume of the orders.

### BRIEF DESCRIPTION OF THE DRAWINGS

In the appended drawings:

FIG. 1 is a schematic view of a system to build mixed pallet layers from full pallet layers according to a first illustrative embodiment of the present invention;

FIGS. 2A and 2B illustrate examples of patterns to respectively palletize boxes of twenty-four and twelve bottles; and

FIG. 3 is a schematic partial side view of a full pallet layers feeding system according to a second illustrative embodiment of the present invention.

### DETAILED DESCRIPTION

In accordance with a first aspect of the present invention, there is provided a system to build mixed pallet layers from full pallet layers comprising:

a palletizing/de-palletizing system, including product accumulators, for receiving full pallet layers, each including identical products from a predetermined group of products, for storing the identical products in a selected one of the product accumulators and for producing mixed pallet layers from selected products retrieved from the product accumulators;

a feeding system for feeding the full pallet layers to the palletizing/de-palletizing system; and

a mixed pallet output system for receiving the mixed pallet layers from the palletizing/de-palletizing system.

According to a second aspect of the present invention, there is provided a system to build mixed pallet layers from full pallet layers comprising:

a table to receive and support the full pallet layers and to support the mixed pallet layers; each of the full pallet layers including identical input products selected from a predetermined group of products;

a plurality of product accumulating rows located adjacent the table for receiving and accumulating the input products;

a product manipulator to pick the identical input products from each one of the full pallet layers on the table, to store the identical input products in a selected one of the accumulating rows, and to form a mixed pallet layer on the table by picking selected products in the accumulating rows and by positioning the selected products according to a mixed layer pattern.

According to a third aspect of the present invention, there is provided a method to build mixed pallet layers comprising receiving full pallet layers, each including identical products selected from a predetermined group of products; uniquely associating to each group of products an accumulator from a series of accumulators; de-palletizing each of the full pallet layers and accumulating each of the identical products included therein in a first selected accumulator from the series of accumulators which is associated to the identical product; and for each of the mixed pallet layers to build:

i) providing a list of selected products from the predetermined group of products to include in said each of the mixed layers to build;

ii) determining a mixed-layer pattern using the list of selected products to include; and

iii) building the mixed pallet layer by retrieving each of the selected products in a second selected group of accumulators from the series of accumulators corresponding to the series of accumulators which are associated to the selected products, and by positioning said selected products according to the mixed-layer pattern; the second selected group of accumulators including accumulators.

Other objects, advantages and features of the present invention will become more apparent upon reading the following non restrictive description of illustrated embodiments thereof, given by way of example only with reference to the accompanying drawings.

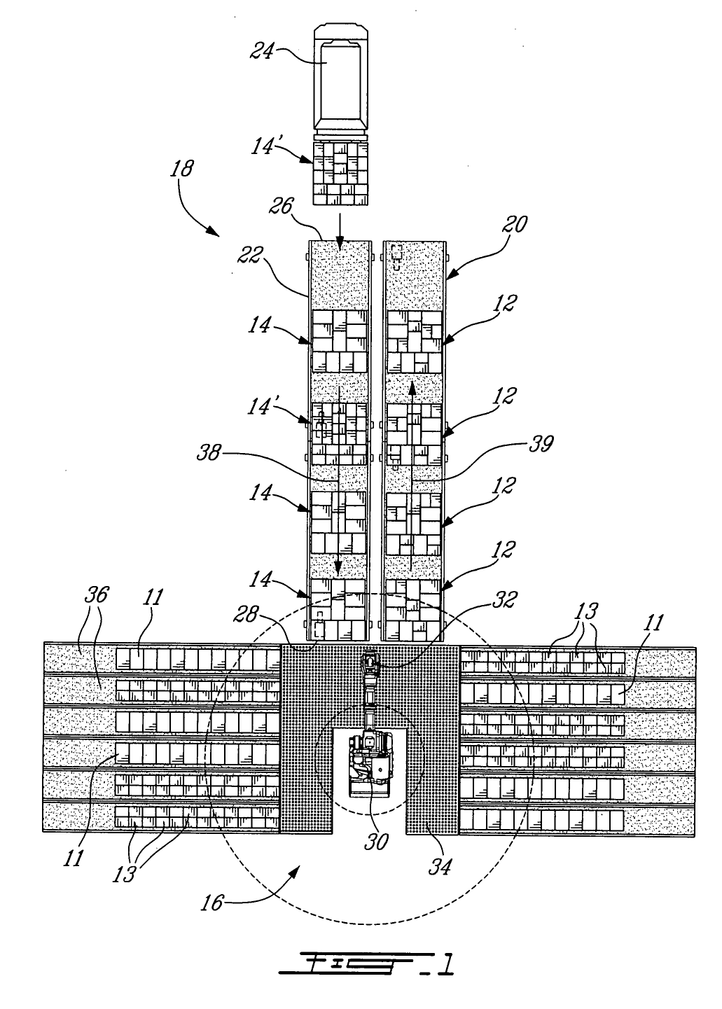

A system 10 to build mixed pallet layers 12 from full pallet layers 14 or 14′ will be described with reference to FIG. 1.

Even though the system 10 will be described with reference to pallets including boxes, the present system and method can be used to build mixed pallet layers from full pallet layers of any type of product that are stackable.

According to the first illustrative embodiment, full pallet layers of identical stock-keeping units (SKU), in the form of first boxes 11 of twenty-four (24) bottles or of second boxes 13 of twelve (12) bottles, are inputted to the system 10. Each full layer 14 or 14′ includes respectively boxes 11 or 13 of identical products selected from a predetermined group of products. For example, it is predetermined that the system 10 will handle the following: boxes of twelve or twenty-four bottles of products A to L for a possibility of 24 different boxes or products. Of course, the number and nature of the products may vary.

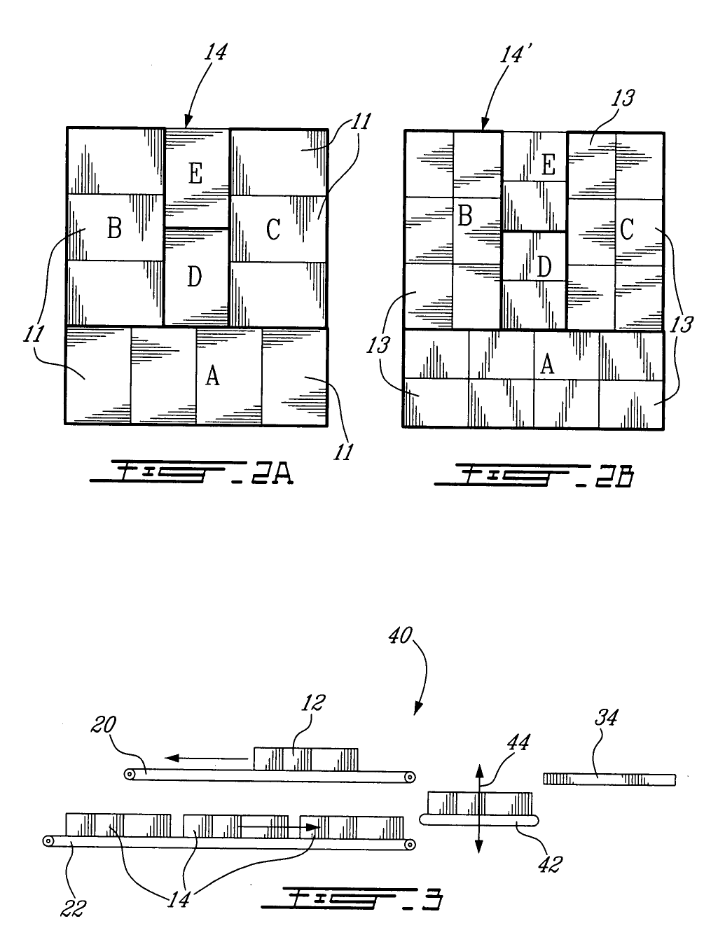

FIGS. 2A and 2B illustrate example of patterns 14-14′ used to respectively palletize boxes of twenty-four and twelve bottles. Other patterns can also be used.

The system 10 comprises a palletizing/de-palletizing system 16, a feeding system 18 for feeding the full pallet layers 14-14′ to the palletizing/de-palletizing system 16; and a mixed pallet output system 20 for receiving the mixed pallet layers 12 from the palletizing/de-palletizing system 16.

The feeding system 18 includes an input conveyor 22 which brings one SKU full layers 14 or 14′ to the palletizing/de-palletizing system 16. As mentioned hereinabove, each of the full layers 14 or 14′ includes SKU selected from a predetermined group of products.

A forklift truck 24 is provided to feed the input conveyor 22 with the full layers 14 or 14′, one at a time and without the pallet. Another conveyor (not shown) or any other suitable means can be provided to feed the input conveyor 22.

The input conveyor 22 allows accumulating the full layers 14-14′ and bringing them to the system 16. The input conveyor 22 is in the form of a belt conveyor equipped with conventional sensors (not shown) allowing to determine the position of the layers 14-14′ thereon. The conveyor 22 includes or is connected to a conventional conveyor controller (not shown) which allows to synchronize the moving of the layers 14-14′ on the conveyor 22 from the input end 26 to the output end 28 thereof with the sensor readings. Since conveyor controllers are believed to be well-known in the art, and for concision purposes, they will not be described herein in more detail.

The palletizing/de-palletizing system 16 includes a product manipulator in the form of a robot 30, provided with a robot tool 32, partially surrounded by a ball table 34, and two series of SKU accumulators, in the form of accumulation conveyors 36, each positioned on a respective side of the ball table 34 adjacent therefrom.

The robot 30 is a conventional robot, such as, without limitation, model IRB 6650 from ABB. Since such a conventional robot is believed to be well-known in the art, and for concision purposes, it will not be described herein in more detail.

The robot 30 is equipped with a tool 32 which allows picking a single box 11 or 13 from a layer 14 or 14′ or from one of the accumulation conveyor 36 and moving such a box 11 or 13 on the ball table 34.

More specifically, the tool 32 is in the form of a gripper allowing to simultaneously grip four of the twenty-four bottle boxes 11 or eight of the twelve bottle boxes 13.

The tool 32 can alternatively includes a vacuum plate equipped with suction cups (not shown) so that boxes 11 or 13 adhere thereto when the suction is activated. The vacuum plate is dimensioned so as to be able to simultaneously pick a plurality of the box 11 and 13.

The movements of the robot 30, including the operation of the tool 32, are controlled by a robot controller (not shown). The operation of the robot 30 is determined by the sequence and configuration of the full layers 14 and 14′ and the type of products therein. This information is either fed to the robot controller or determined in operation by robotic vision. In this later case, the robot tool 32 further includes proper sensor (not shown). As it is conventionally known, artificial vision can be achieved in many ways, using for example any one or a combination of smart sensors, conventional sensors, video camera provided with image processing, laser sensor, etc. Since robotic vision and robot controllers are believed to be well known in the art, and for concision purposes, they will not be explained furtherin.

The ball table 34 includes a plurality of transfer balls which allow free movement of the boxes 11 and 13 thereon. The ball table 34 is generally leveled with both the input and output conveyors 22 and 20 so as to facilitate the transfer of boxes between the conveyor 22 and the table 34 and between the table 34 and the conveyor 20.

The accumulation conveyors 36 are all identical. Each of the accumulation conveyors 36 is in the form of a motorized conveyor which allows selectively moving boxes towards or away from the ball table 34 and the robot 30 in a palletizing or de-palletizing mode respectively. For that purpose, each of the accumulation conveyor's actuating motor (not shown) is coupled to an accumulation conveyor controller (not shown) which controls the movement of the conveyors 36 depending on the robot 30 operation.

Each accumulation conveyor 36 also includes level sensors coupled to the accumulation conveyor controller to determine the number of boxes of products 11 or 13 included therein. The level can also be more simply determined by keeping account of the number of boxes stored in each row 36 or withdraw therefrom.

The number of accumulation conveyors 36 is such that there is the same number of conveyors 36 than the predetermined group of products expected. This way, each of the conveyors 36 is assigned a different product type which, according to the first illustrative embodiment, can be packaged either in a twelve-bottle box 13 or in a twenty-four-bottle box 11.

Still according to the first illustrative embodiment, the twelve-bottle-boxes 13 are simultaneously stored two-by-two in a conveyor line 36, while a single twenty-four-bottle box 11 is store at once in a row by the robots 30. Other storing arrangement in the accumulators 36 can of course be provided, depending for example on the relative sizes of the boxes 11 and 13 and width of the conveyors 36.

The width of each the accumulation conveyors 36 is adapted to the dimension of the products that it is intended to receive. For example, the accumulation conveyors 36 are about 5 cm wider than the width of the boxes 11. The length of each of the accumulators 36 is also adapted to the maximum number of boxes 11 or 13 it is expected to receive.

Finally, each of the input and output conveyor controllers, accumulation conveyor controller and robot controller are coupled to a system controller which coordinates and synchronizes the operation of the components of the system 10.

In operation, the system 10 to build mixed pallet layers 12 from full pallet layers 14 or 14′ alternates between a de-palletizing mode and a palletizing mode.

De-palletizing Mode

In the de-palletizing mode, the forklift truck 24 feeds the input conveyors 22 with single layers 14 or 14′ of identical products. The feeding frequency or speed is determined by the level of accumulation in the conveyor 22. Of course, the level of accumulation indirectly depends on the level of accumulation in the accumulation conveyors 36 and the level of accumulation in the output conveyor 20, and vice-versa.

When the palletizing/de-palletizing system 16 is ready to de-palletize the first layer 14 at the output end 28 of the input conveyor 22, this first layer 14 is transferred from the conveyor 22 to the ball table 34 by energizing the input conveyor 22 (see arrow 38). The robot 30 further pulls the layer 14 from the conveyor 22.

A de-palletizing sequence then begins, where the robot 30 positions the tool on a first group of boxes A (see FIG. 2A), the suction is activated and the robot 30 then drags the group of boxes A by sliding them onto the ball table 34 towards the accumulation conveyor 36 which has been designated to receive the product included in the current layer 14. The robot 30 then proceeds similarly for each group from B to E. It has been found that proceeding according to such a sequence increase the de-palletizing efficiency. Other de-palletizing sequence can also be used depending on the configuration of the SKU full layers and the geometry of the boxes for example.

It is reminded that the reference numerals 14 and 14′ distinguish two difference layer patterns and that the boxes from two different layers 14 can each include different products. As it has been explained hereinabove, the palletizing/de-palletizing system 16 can distinguish between layers of different types of products within the predetermined groups of products either using artificial vision or by registering the feeding sequence of layers.

Palletizing Mode

In operation, while in the palletizing mode, a mixed layer configuration is determined by the system controller providing the list of product boxes desired using any well-known mixed layer determination algorithm.

Then, the system controller knowing which accumulation conveyor 36 includes which product boxes, the proper accumulation conveyor 36 is activated so as to push the first case(s) in the row onto the ball table 34.

The robot 30 positions the tool 32 on the case(s) 11 or 13 and the suction is activated. The robot 30 then drags the case(s) 11 or 13 at the proper position onto the output conveyor 20 near its longitudinal end adjacent the ball table 34. This proper position is determined by the mixed-layer determination algorithm and the position of any previously positioned boxes. This sequence of picking and positioning a box onto the output conveyor 20 is repeated until a mixed-layer 12 is formed.

The system 10 can be configured so as to create the mixed-layer row by row near the edge of the output conveyor 20 adjacent the ball table 34, wherein, when a row is formed, the output conveyor 20 advances from the corresponding space to receive the next row, etc, until the layer 12 is formed.

According to a further specific embodiment, the output conveyor 20 remains immobile while the mixed layer 12 is formed.

According to both specific embodiments, when the mixed-layer 12 is completed, the output conveyor 20 is energized to advance the layer 12 towards its output end (see arrow 39), where it is seized by the forklift 24 to be put, for example, on a pallet (not shown).

Turning now to FIG. 3, a system 40 to build mixed pallet layers 12 from full pallet layers 14 according to a second illustrative embodiment will now be described. Since the system 40 is very similar to the system 10, only the differences between these two systems will be described herein.

The input and output conveyors 22 and 20 are mounted on top of each other. Sufficient space is of course provided between the two conveyors 20-22 to allow for their respective components.

Even though the output conveyor 20 is illustrated on top of the input conveyor 22 in FIG. 3, the opposite can also be considered. The conveyor positioned on top is mounted on a frame (not shown).

The system 40 further comprises a lift 42 between the pair of input/output conveyors 20-22 and the ball table 34 of the palletizing/de-palletizing system 16. The lift 42 is provided for reciprocal movement between up and down positions (see arrow 44). While in the down position, the lift platform is generally leveled with the input conveyor 22 so as to receive a SKU full layer 14 (or 14′). In the up position, the lift platform is generally leveled with both the output conveyor 20 and the ball table 34. While in this position, a full layer 14 coming from the input conveyor 22 can be transferred to the palletizing/de-palletizing system 16 or boxes from the palletizing/de-palletizing system 16 can be transferred to the output conveyor 20 as described hereinabove with reference to the first illustrative embodiment.

To ease the transfer of boxes from the lift 42, the lift 42 is in the form of a conveyor.

The sequence of operation of the system 42 is as described with reference to the system 10, with the additional step in the de-palletizing mode that the lift 42 has to be raised from its down to its up position to transfer a SKU layer 14 from the input conveyor 22 to the palletizing/de-palletizing system 16.

The lift 42 can be directly controlled by the system controller, or by a dedicated controller coupled to the system controller.

It is to be noted that many modifications could be done to the above-described illustrative embodiments.

For example, even though the input conveyor 22 is illustrated as being a one-section conveyor, a two-section conveyor or a conveyor including any number of sections, aligned or not, can also be provided with the feeding system 18.

The input and output conveyors 22 and 20 are not limited to belt-type conveyors. Any one of the input and output conveyors 22 and 20 can be in the form of a roller conveyor, mat top conveyor, table top conveyor for example.

The number and function of the controllers may vary. For example, a single system controller can be used to manage the overall operation of the system 10 or 40, the operation of the robot 30 and of the accumulation conveyors 36.

Depending on the expected quantity for a particular product, the accumulation conveyor controller can be program to recognize and manage more than one conveyor 36 for a single product.

Also, a palletizing/de-palletizing system 16 according to the present invention is not limited to the configuration illustrated in FIG. 1, wherein the accumulation conveyors 36 are limited to being positioned on both sides of the ball table 34 so as to be generally parallel. Other configuration can be provided depending on the application, for example, including, without limitations, disposing accumulation conveyors 36 radially around the robot 30.

Other types of accumulators can be used to accumulate the products such as any types of conveyors.

The product manipulator can be the form of a conventional gantry robot (not shown) equipped with the tool 32. When the palletizing/de-palletizing system is provided with such a gantry whose aim extends above the accumulation conveyors, the accumulation conveyors can then be of the roller un-motorized type.

The product manipulator can have any other form having at least three degrees of freedom and allowing to pick boxes of products 11 or 13 from one of the full pallet layers 14 or 14′ on the table 34, to store the products 11 or 13 in a selected one of the accumulating rows 36, and to form a mixed pallet layer 12 on the table 34 by picking selected boxes of products 11 or 13 in the accumulating rows 34 by positioning the selected products 11 or 13 according to a mixed layer pattern.

The feeding system 18 can take other form allowing to bring full pallet layers to the palletizing/de-palletizing system 16. For example, a table (not shown), adjacent the ball table 34 can be used to received the full pallet layers 14-14′ from the forklift truck 24. Also, a conventional de-palletizing system (not shown) can be used adjacent the input conveyor 22 to receive pallets including full layers 14 or 14′ of identical products and to de-stack those pallets for feeding the input conveyor 22 with full layers. A similar system, further provided with palletizing capability, can be provided at the end of the output conveyor 20.

Although the present invention has been described hereinabove by way of illustrated embodiments thereof, it can be modified, without departing from the spirit and nature of the subject invention as defined in the appended claims.

What is claimed is:

1. A system to build mixed pallet layers from full pallet layers comprising:
a palletizing/de-palletizing system, including product accumulators, for receiving full pallet layers, each including identical products from a predetermined group of products, for storing the identical products in a selected one of the product accumulators and for producing mixed pallet layers from selected products retrieved from the product accumulators;
a feeding system for feeding the full pallet layers to the palletizing/de-palletizing system; and
a mixed pallet output system for receiving the mixed pallet layers from the palletizing/de-palletizing system.

2. A system as recited in claim 1, wherein the palletizing/de-palletizing system further includes a product manipulator for said storing the identical products in a selected one of the product accumulators and said producing mixed pallet layers from selected products retrieved from the product accumulators.

3. A system as recited in claim 2, wherein the product manipulator includes a robot provided with a tool.

4. A system as recited in claim 3, wherein the tool includes a gripper for selectively causing at least one of the identical products to adhere thereto.

5. A system as recited in claim 4, wherein the gripper is configured and sized so as to simultaneously pick a plurality of the identical products.

6. A system as recited in claim 3, wherein the palletizing/de-palletizing system further includes a ball table surrounding the robot for facilitating said storing the identical products in a selected one of the product accumulators and said producing mixed pallet layers from selected products retrieved from the product accumulators.

7. A system as recited in claim 2, wherein the product manipulator includes a gantry provided with a tool.

8. A system as recited in claim 1, wherein the feeding system includes an input conveyor.

9. A system as recited in claim 8, wherein the input conveyor being further to accumulate the full pallet layers.

10. A system as recited in claim 8, wherein the feeding system further includes a forklift to feed the input conveyor with the full pallet layers.

11. A system as recited in claim 1, wherein the mixed pallet output system includes an output conveyor.

12. A system as recited in claim 1, wherein the product accumulators includes accumulation conveyors.

13. A system as recited in claim 1, wherein the feeding system includes a first conveyor and the mixed pallet output system includes a second conveyor; one of the first and second conveyors is positioned on top of the other one of the first and second conveyors; the system further comprising a lift for reciprocal movement between the palletizing/de-palletizing system and the other one of the first and second conveyors.

14. A system as recited in claim 1, wherein the palletizing/de-palletizing system is a first palletizing/de-palletizing system; the feeding system and the mixed pallet output system are both parts of a second conventional palletizing/de-palletizing system; wherein a de-palletizing part of the second conventional palletizing/de-palletizing system being for feeding the full pallet layers to the first palletizing/de-palletizing system and a palletizing part of the second conventional palletizing/de-palletizing system being for receiving the mixed pallet layers.

15. A system as recited in claim 1, wherein the identical products are contained in a box.

16. A system to build mixed pallet layers from full pallet layers comprising:
a table to receive and support the full pallet layers and to support the mixed pallet layers; each of the full pallet layers including identical input products selected from a predetermined group of products;
a plurality of product accumulating rows located adjacent the table for receiving and accumulating the input products;
a product manipulator to pick the identical input products from each one of the full pallet layers on the table, to store the identical input products in a selected one of the accumulating rows, and to form a mixed pallet layer on the table by picking selected products in the accumulating rows and by positioning the selected products according to a mixed layer pattern.

17. A system as recited in claim 16, wherein the product manipulator is a robot provided with a tool.

18. A system as recited in claim 17, wherein the tool includes a gripper for selectively picking at least one of the identical input products.

19. A system as recited in claim 18, wherein the gripper is configured and sized so as to cause a plurality of the identical input products to adhere thereto.

20. A system as recited in claim 16, wherein the plurality of product accumulating rows include accumulation conveyors.

21. A system as recited in claim 16, wherein the table is a ball table.

22. A system as recited in claim 16, further comprising an input conveyor adjacent the table for feeding the full pallet layers to the table.

23. A system as recited in claim 22, wherein the input conveyor and the table are generally levelled.

24. A system as recited in claim 16, further comprising an output conveyor adjacent the table for receiving mixed pallet layers.

25. A system as recited in claim 24, wherein the output conveyor and the table are generally levelled.

26. A method to build mixed pallet layers comprising:
receiving full pallet layers, each including identical products selected from a predetermined group of products;
uniquely associating to each group of products an accumulator from a series of accumulators;
de-palletizing each of the full pallet layers and accumulating each of the identical products included therein in a first selected accumulator from the series of accumulators which is associated to the identical product;
for each of the mixed pallet layers to build:
i) providing a list of selected products from the predetermined group of products to include in said each of the mixed layers to build;
ii) determining a mixed-layer pattern using the list of selected products to include; and
iii) building the mixed pallet layer by retrieving each of the selected products in a second selected group of accumulators from the series of accumulators corresponding to the series of accumulators which are associated to the selected products, and by positioning said selected products according to the mixed-layer pattern; the second selected group of accumulators including accumulators.

27. A method as recited in claim 26, wherein each of the full pallet layers is characterized by a pattern; said de-palletizing each of the full pallet layers is achieved following a predetermined sequence based on the pattern characterizing said each of the full pallet layers.
